(19) United States
(12) Patent Application Publication
(10) Pub. No.: US 2025/0314799 A1
(43) Pub. Date: Oct. 9, 2025

(54) SYSTEMS AND METHODS FOR DENOISING NUCLEAR MAGNETIC RESONANCE (NMR) MEASUREMENT

(71) Applicant: ConocoPhillips Company, Houston, TX (US)

(72) Inventors: Tianmin Jiang, Houston, TX (US); Ronald J.M. Bonnie, Houston, TX (US)

(21) Appl. No.: 19/081,187

(22) Filed: Mar. 17, 2025

Related U.S. Application Data
(60) Provisional application No. 63/574,457, filed on Apr. 4, 2024.

(51) Int. Cl. G01V 3/38; G01V 3/32

(52) U.S. Cl. CPC G01V 3/38; G01V 3/32

(57) ABSTRACT

Systems and methods are provided for reducing noise in nuclear magnetic resonance (NMR) data by filtering the NMR data based on the noise harmonic of the NMR data. The NMR data is generated using an NMR device in a well bore hole to perform a pulse sequence (e.g., an inversion recovery pulse sequence followed by a Carr-Purcell-Meiboom-Gill (CPMG) pulse sequence). When significant noise is observed, a Fast-Fourier Transform (FFT) transforms the echo data to identify a fundamental frequency (and harmonics) of the noise, and the window width of a moving filter is based on the fundamental frequency. The moving filter is used to determine a threshold, and the amplitudes of frequency coefficients within the window that exceed the threshold are reduced to generate the filtered data, which is transformed (e.g., via IFFT) back to the time domain to provide improved echo data for further NMR analysis.

### CROSS-REFERENCE TO RELATED APPLICATIONS

The present application claims priority to U.S. Provisional Patent Application No. 63/574,457 filed on Apr. 4, 2024, which is incorporated by reference in its entirety herein.

### TECHNICAL FIELD

Aspects of the present disclosure relate generally to systems and methods for reservoir production and more particularly to reservoir development using Nuclear Magnetic Resonance (NMR) measurements.

### BACKGROUND

Reservoir characterization for oil and gas extraction operations often involves an understanding of in-situ fluid types and volumetrics. Some techniques for well development use Nuclear Magnetic Resonance (NMR) to determine the amount of hydrocarbon present and other reservoir characteristics at a particular location in the reservoir. NMR is a physical phenomenon in which hydrogen nuclei in a constant magnetic field are perturbed by an oscillating magnetic field and respond by producing a distinct electromagnetic signal. NMR logging uses this phenomenon to create a controlled magnetic field and transmit one or more radio frequency (RF) pulses into the reservoir to magnetically polarize the hydrogen nuclei of the hydrocarbons and water, thus creating an NMR response (e.g., a spin echo).

The NMR response can be used to determine various physical values, such as the amplitudes of echo signals and the relaxation times for the transverse and longitudinal magnetization. For example, the NMR response of the hydrogen nuclei can be related to the quantity of hydrogen nuclei present. Therefore, measuring the NMR response after the RF pulses can provide information about the hydrogen nuclei and corresponding reservoir characteristics. However, the NMR response can sometimes be noisy. Therefore, reducing the noise while preserving the NMR signal can present a challenge to obtaining high-quality NMR data.

It is with these observations in mind, among others, that various aspects of the present disclosure were conceived and developed.

### SUMMARY

Implementations described and claimed herein address the foregoing problems by providing systems and methods for NMR measurement. In some examples, a method of denoising nuclear magnetic resonance (NMR) data comprises: generating NMR data using an NMR device in a borehole of a well; identifying a noise harmonic in the NMR data; applying a first filter to the NMR data to generate filtered NMR data, wherein the first filter is based on the noise harmonic that is identified in the NMR data; determining one or more spin relaxation times based on the filtered NMR data; and performing an analysis using the one or more spin relaxation times to generate an MR image and/or determine a reservoir property of the well.

Additionally, in some instances, the reservoir property of the well includes porosity, permeability, wettability, irreducible water saturation, and irreducible oil saturation.

In some scenarios, the one or more spin relaxation times comprise longitudinal (T1) relaxation times and transverse (T2) relaxation times at respective depths along the bore hole of the well and/or at transverse locations with respect to the borehole of the well. Moreover, the analysis includes determining the reservoir property of the well as a function of the depth along the borehole and/or a function of the transverse location with respect to the borehole of the well.

In some examples, the method further comprises identifying the noise harmonic in the NMR data includes determining whether the NMR data includes noise that is greater than a predefined noise threshold; determining the one or more spin relaxation times based on the NMR data without applying the first filter to the NMR data, when the noise of the NMR data is determined to not exceed the predefined noise threshold and needs further analysis; and applying the first filter to the NMR data and determining the one or more spin relaxation times based on the filtered NMR data, when the noise of the NMR data is determined to exceed the predefined noise threshold.

In some instances, determining whether the noise of the NMR data is greater than the predefined noise threshold further includes determining in a time domain whether the NMR data includes the noise; and, when the NMR data is determined to include the noise, transforming the NMR data to a frequency domain and comparing the noise in the frequency domain to the predefined noise threshold to determine whether the noise of the NMR data is greater than the predefined noise threshold.

In some examples, the first filter is applied to the NMR data in a frequency domain by: transforming the NMR data to the frequency domain to obtain frequency-domain NMR data; determining amplitude thresholds for respective frequency windows of a moving average applied to the frequency-domain NMR data, wherein a window size of the respective frequency windows is based on a fundamental frequency of the noise harmonic; reducing an amplitude of a frequency component within a given frequency window of the respective frequency windows, when the frequency component exceeds the amplitude threshold corresponding to the given frequency window, to generate filtered frequency-domain NMR data; and transforming the filtered frequency-domain NMR data from the frequency domain to the time domain to generate filtered NMR data. Additionally, reducing the amplitude of the frequency component within the given frequency window can further include that the frequency component that exceeds the amplitude threshold corresponding to the given frequency window is reduced to have an amplitude that is equal to the amplitude threshold. Moreover, another amplitude of the frequency component within the given frequency window that does not exceed the amplitude threshold corresponding to the given frequency window.

In some scenarios, generating the NMR data includes: positioning a radio frequency (RF) transceiver in the bore hole of the well; generating a magnetic field in the bore hole; generating, using the RF transceiver, an inversion recovery pulse sequence or a saturation recovery pulse sequence; generating, using the RF transceiver, a Carr-Purcell-Meiboom-Gill (CPMG) pulse sequence including a plurality of P180 RF pulses, wherein the magnetic field, the inversion recovery pulse sequence, and the CPMG pulse sequence cause a nuclear magnetic resonance (NMR) response from a hydrocarbon pool within a transmission range of the RF transceiver; and determining one or more spin magnetization values of the hydrocarbon pool from the NMR response after a P180 RF pulse of the plurality of P180 RF pulses. Additionally, the method can include determining, for the hydrocarbon pool and based on the one or more spin magnetization values, at least one of: a fluid volume; a hydrocarbon pool geometry; a fluid viscosity; a pore geometry; or a fluid-pore interaction. Moreover, the method can include using a result of the analysis to cause a well operation to be performed for the well site based on the one or more spin magnetization values. And the well operation can include at least one of: selecting a drilling site; drilling to a particular drilling depth; performing well completion for the well bore hole; performing a shut-in procedure for the well bore hole; or performing an additional hydrocarbon pool characterization.

In some examples, a system is provided for denoising nuclear magnetic resonance (NMR) data. The system comprises a nuclear magnetic resonance (NMR) device that includes a magnet configured to generate a magnetic field, and a radio frequency (RF) transceiver configured to transmit one or more pulse sequences and receive echo pulse signals. The system further includes one or more processors; and a memory storing instructions. When executed by the one or more processors, the stored instructions configure the system to: generate NMR data using the NMR device in a in bore hole of a well; identify a noise harmonic in the NMR data; apply a first filter to the NMR data to generate filtered NMR data, wherein the first filter is based on the noise harmonic that is identified in the NMR data; determine one or more spin relaxation times based on the filtered NMR data; and perform an analysis using the one or more spin relaxation times to generate an MR image and/or determine a reservoir property of the well.

In some instances, the reservoir property of the well includes porosity, permeability, wettability, irreducible water saturation, and irreducible oil saturation.

In some examples, when executed by the one or more processor, the stored instructions further configure the system to: identify the noise harmonic in the NMR data includes determining whether the NMR data includes noise that is greater than a predefined noise threshold; determine the one or more spin relaxation times based on the NMR data without applying the first filter to the NMR data, when the noise of the NMR data is determined to not exceed the predefined noise threshold and needs further analysis; and apply the first filter to the NMR data and determining the one or more spin relaxation times based on the filtered NMR data, when the noise of the NMR data is determined to exceed the predefined noise threshold.

Further, the system can include that, when executed by the one or more processor, the stored instructions further configure the system to determine whether the noise of the NMR data is greater than the predefined noise threshold further by determining in a time domain whether the NMR data includes the noise; and, when the NMR data is determined to include the noise, transforming the NMR data to a frequency domain and comparing the noise in the frequency domain to the predefined noise threshold to determine whether the noise of the NMR data is greater than the predefined noise threshold.

In some instances, wherein the first filter is applied to the NMR data in a frequency domain by: transforming the NMR data to the frequency domain to obtain frequency-domain NMR data; determining amplitude thresholds for respective frequency windows of a moving average applied to the frequency-domain NMR data, wherein a window size of the respective frequency windows is based on a fundamental frequency of the noise harmonic; reducing an amplitude of a frequency component within a given frequency window of the respective frequency windows, when the frequency component exceeds the amplitude threshold corresponding to the given frequency window, to generate filtered frequency-domain NMR data; and transforming the filtered frequency-domain NMR data from the frequency domain to the time domain to generate filtered NMR data.

In some examples, reducing the amplitude of the frequency component within the given frequency window comprises that the frequency component that exceeds the amplitude threshold corresponding to the given frequency window is reduced to have an amplitude that is equal to the amplitude threshold. Further, another amplitude of the frequency component within the given frequency window that does not exceed the amplitude threshold corresponding to the given frequency window remains unchanged when applying the first filter.

The system can further include that, when executed by the one or more processor, the stored instructions further configure the system to generate the NMR data by: positioning the RF transceiver in the bore hole of the well; generating a magnetic field in the bore hole; generating, using the RF transceiver, an inversion recovery pulse sequence; generating, using the RF transceiver, a Carr-Purcell-Meiboom-Gill (CPMG) pulse sequence including a plurality of P180 RF pulses, wherein the magnetic field, the inversion recovery pulse sequence, and the CPMG pulse sequence cause an NMR response from a hydrocarbon pool within a transmission range of the RF transceiver; and determining one or more spin magnetization values of the hydrocarbon pool from the NMR response after a P180 RF pulse of the plurality of P180 RF pulses.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate implementations of systems, methods, and apparatuses consistent with the disclosed subject matter and, together with the description, serve to explain advantages and principles consistent with the disclosed subject matter, in which:

FIG. 1 depicts an example system for Nuclear Magnetic Resonance (NMR) measurement, in accordance with certain non-limiting examples of the disclosure herein;

FIG. 2 depicts an example of a portion of an NMR pulse sequence that includes an inversion recovery pulse sequence and a Carr-Purcell-Meiboom-Gill (CPMG) pulse sequence, in accordance with certain non-limiting examples of the disclosure herein;

FIG. 3 depicts another example of a portion of an NMR pulse sequence that includes an inversion recovery pulse sequence and a CPMG pulse sequence, in accordance with certain non-limiting examples of the disclosure herein;

FIG. 4A depicts a first sub-measurement of the pulse sequence in FIG. 3, in accordance with certain non-limiting examples of the disclosure herein;

FIG. 4B depicts a second sub-measurement of the pulse sequence in FIG. 3, in accordance with certain examples of the disclosure herein;

FIG. 4C depicts a third sub-measurement of the pulse sequence in FIG. 3, in accordance with certain non-limiting examples of the disclosure herein;

FIG. 5 depicts an example of a time-domain plot of noisy echo data that is generated at respective well depths; in accordance with certain non-limiting examples of the disclosure herein;

FIG. 6A depicts an example of a frequency-domain plot of non-noisy echo data; in accordance with certain non-limiting examples of the disclosure herein;

FIG. 6B depicts an example of a frequency-domain plot of noisy echo data with a noise harmonic; in accordance with certain non-limiting examples of the disclosure herein;

FIG. 7A depicts an example of a plot of the real part of the frequency coefficients of the noisy echo data and the filtered echo data; in accordance with certain examples of the disclosure herein;

FIG. 7B depicts an example of a plot of the imaginary part of the frequency coefficients of the noisy echo data and the filtered echo data; in accordance with certain non-limiting examples of the disclosure herein;

FIG. 8A depicts an example of a plot in the time domain of the real part of the noisy echo data and the filtered echo data; in accordance with certain examples of the disclosure herein;

FIG. 8B depicts an example of a plot in the time domain of the imaginary part of the noisy echo data and the filtered echo data; in accordance with certain non-limiting examples of the disclosure herein;

FIG. 9 depicts an example of a plot illustrating side-by-side the original echo data (left), i.e., the noisy echo data by itself; the frequency coefficients of the noisy and filtered echo data (middle); and the noisy and filtered echo data represented in the time domain (right); in accordance with certain non-limiting examples of the disclosure herein;

FIG. 10 depicts a flow diagram of an example of method of acquiring, denoising, and using echo data; in accordance with certain non-limiting examples of the disclosure herein;

FIG. 11 depicts a flow diagram of an example of a process for denoising the echo data; in accordance with certain non-limiting examples of the disclosure herein;

FIG. 12 depicts a plot of an example of a T₁-T₂ signatures generated from echo; in accordance with certain non-limiting examples of the disclosure herein;

FIG. 13 depicts a block diagram of an example of a process for fluid porosity from an NMR log; in accordance with certain non-limiting examples of the disclosure herein;

FIG. 14 depicts an example of a computing system that can implement various systems and methods discussed herein; in accordance with certain non-limiting examples of the disclosure herein.

### DETAILED DESCRIPTION

Aspects of the present disclosure involve systems and methods for NMR measurement and denoising that result in improved echo data having reduced noise that leads to improved accuracy for spin magnetization amplitude calculations and estimation of the relaxation times. The techniques disclosed herein address noise in the echo data and how to reduce said noise, especially when the noise has a harmonic component. The systems and methods disclosed herein can be used for characterizing reservoir formations containing fluid components. Further, the systems and methods disclosed herein can be used with fluid components with relaxation times in the same order of magnitude as the RF pulse duration (e.g., shale and/or tight rock formations).

Understanding in-situ fluid types and volumetrics is helpful for reservoir characterization. Nuclear Magnetic Resonance (NMR) well logging is a tool that can be used to understand in-situ fluid types and volumetrics. For example, the acquisition of the relaxation time for the longitudinal magnetization (T1) and the relaxation time for transverse magnetization (T2) can be used to create an intensity map of T1-T2 relaxation time distributions. The NMR data (e.g., the T1-T2 relaxation time distributions) can provide unique signatures of formation fluids, such as gas, immobile hydrocarbon, producible oil, immobile water, and free water. Further, the NMR data can be used to identify fluid and matrix properties, including fluid viscosity, pore geometry, and fluid-pore interaction.

In practical NMR logging, the noises from the NMR logging tool and from the environment can affect the NMR echo amplitude, resulting in artifacts or otherwise obscuring the signals, information, and signatures represented in the NMR data. Significantly, the noise in the NMR data can adversely impact NMR porosity and T1-T2 map of the formation fluids, resulting in inaccurate calculations of formation fluid porosity and saturation from fluid typing. For example, noise can be observed in echo data acquired during NMR logging, if left uncorrected this noise will adversely affect all downstream results derived from the echo data, including, e.g., T1-T2 maps that are derived from the echo data and the calculations of formation fluid porosity and saturation from fluid typing that are derived from the T1-T2 maps.

Consider for example a case in which the NMR data is acquired by the tool in the borehole filled with oil-based mud. In this case, for example, the echo data can be affected by the environmental noises with a fundamental frequency of tens of Hz and harmonics. For improved results, the noise can be mitigated/reduced in the echo data to generated corrected echo data before processing the corrected echo data to determine echo amplitudes and magnetization relaxation values.

According to certain non-limiting examples, the systems and methods disclosed herein denoise the echo data using a moving filter. For example, the raw echo data can initially undergo inspection to determine whether there is sufficient noise to merit denoising. This quality check of the raw echo data can include a time-domain phase and a frequency domain phase. The time-domain phase of the quality check can include an inspection to see if there are significant noises compared to baseline/normal cases. If the echo data is determined to be noisy, the frequency-domain phase of the quality check is performed by performing a Fast-Fourier Transform (FFT) on the echo data. In the frequency-domain phase of the quality check, the frequency coefficients (i.e., the echo data after FFT, which is denoted as ECHO_{FFT}) can plotted as a function of frequency. In the frequency domain, it can be observed whether there is harmonic noise (i.e., noise that has harmonics of a fundamental frequency). As discussed above, it has been observed that, in some well-reservoir environments, there can be significant environmental noise with a fundamental frequency of tens of Hz and harmonics are observed. When such noise is observed (e.g., using the frequency-domain plot of the echo data), a moving filter can be applied to ECHO_{FFT} data to get the corrected data of the ECHO_{FFT} data (ECHO_{FFT-Corr}). The moving filter can use a fundamental frequency of the noise to set a window width of a moving average, which is used to determine a threshold. The moving filter reduces the amplitudes of frequency coefficients of the ECHO_{FFT} data that are within the window and that exceed the determined threshold. next, an inverse-Fast-Fourier Transform (IFFT) is performed on ECHO_{FFT-Corr} data to generate the corrected echo data (ECHO_{Corr})

According to certain non-limiting examples, the systems and methods disclosed herein use improved processes to process the corrected echo data ECHO_{Corr}. In some examples, the fundamental Bloch equations on which current calculations are improved to include the relaxation effect on spin magnetization during a P180 RF pulse. An initial assumption that relaxation times of the hydrogen nuclei are at least an order of magnitude greater than the pulse duration is omitted and/or replaced with a consideration that the relaxation times are within an order of magnitude of the pulse duration. This provides a more accurate method to calculate the spin magnetizations that corrects the amplitude error created by the initial assumption, improving the accuracy of the NMR measurement system.

For instance, a modified inversion algorithm can be developed based on these techniques to correct the signal amplitude. Accordingly, unique signatures of formation fluids, such as gas, immobile hydrocarbon, producible oil, immobile and free water, can be detected at a higher level of granularity and/or accuracy. Furthermore, these techniques can provide better information regarding fluid and matrix properties, including fluid viscosity, pore geometry and fluid-pore interaction such that well operations can be improved (e.g., selecting a drilling site, determining a drilling depth, determining to perform well completion, performing a shut-in procedure for the well borehole, and the like). Generally, the presently disclosed technology provides a modified inversion algorithm for data processing considering the relaxation effect on spin magnetization during 1800 RF pulse, thereby providing more accurate NMR results from the measured data. Additional advantages will become apparent from the disclosure herein.

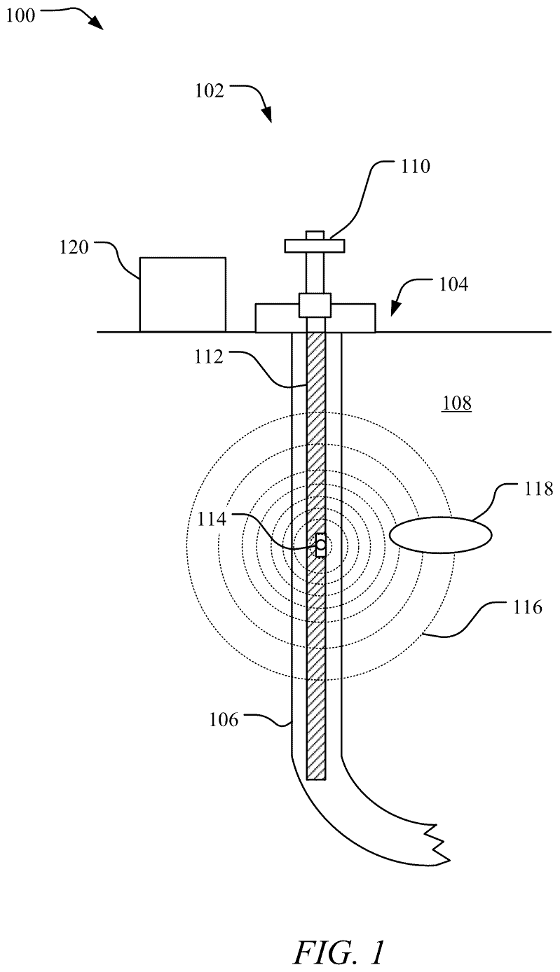

FIG. 1 illustrates an example system 100 for NMR measurement with amplitude correction at a well of a reservoir production environment 102. The reservoir production environment 102 can be a well site 104 with a borehole 106 into a subterranean feature 108 (e.g., an underground reservoir) for extracting oil or gas from the subterranean feature 108.

In some instances, the system 100 includes a wellhead assembly 110 connected to a string assembly 112 which is inserted into the bore hole 106. The string assembly 112 can include an NMR unit 114 with an electromagnet, an RF transceiver, an antenna, and various sensors, hardware, and other computing device components to generate a constant and static magnetic field, generate the RF pulses 116 into the subterranean feature 108, and detect an NMR response. For instance, the RF pulses 116 can collide with one or more hydrocarbon pools 118 (e.g., and/or water pools) within a transmission range of the RF transceiver. In response, the hydrocarbon pool 118 can transfer the increased nuclear spin energy into the surrounding environment as its precession reaches equilibrium, creating the NMR response including one or more relaxation times and/or echo amplitudes representing spin magnetization. The system 100 can also include one or more control center(s) 120 to house various equipment for controlling the NMR measurement techniques discussed herein.

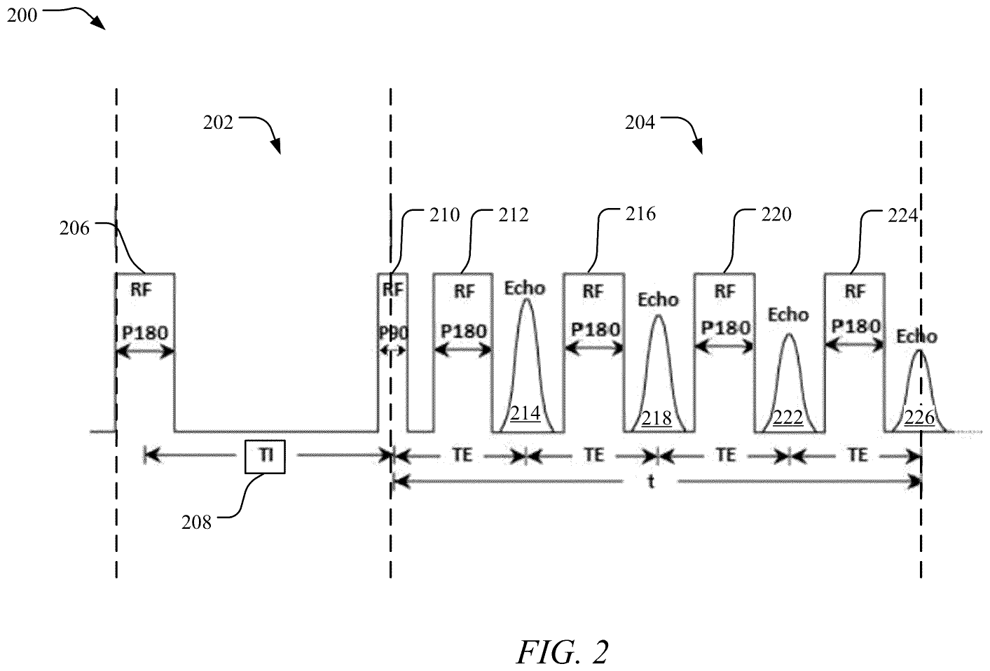

FIG. 2 illustrates an example system 200 for NMR measurement with amplitude correction including an inversion recovery pulse sequence 202 (e.g., an inversion recovery pulse sequence) and a Carr-Purcell-Meiboom-Gill (CPMG) pulse sequence 204, which can form at least a portion of the system depicted in FIG. 1. This NMR logging technique can provide simultaneous acquisition of relaxation time corresponding to the properties of the hydrogen pool 118 including a longitudinal relaxation time (T₁) in the longitudinal direction and a transverse relaxation time (T₂) in the transverse direction to create an intensity map of NMR T₁-T₂ relaxation time distributions.

For instance, the RF pulses 116 generated by the system 200 can include the inversion recovery pulse sequence 202, which has an initial inversion recovery pulse 206 followed by an Inversion time (TI) 208. The initial inversion recovery pulse 206 can be a P180 pulse (e.g., an RF pulse with a width and intensity causing a 180° rotation of the magnetization vector on the Bloch sphere). The inversion recovery pulse sequence can then be followed by the CPMG pulse sequence 204 after the Inversion time (T1) 208. For instance, the CPMG pulse sequence 204 includes a P90 pulse 210 (e.g., an RF pulse with a width and intensity causing a 90° rotation of the magnetization vector on the Bloch sphere) followed by a first P180 echo pulse 212, a first echo period 214, a second P180 pulse 216, a second echo period 218, a third P180 pulse 220, a third echo period 222, a fourth P180 pulse 224, a fourth echo period 226, and can repeat in this manner for time (t).

In some scenarios, the T₁ and the T₂ values are in the millisecond range and are much longer than the duration of the initial inversion recovery pulse 206, which can be in the microsecond range. In these scenarios, a spin echo magnetization amplitude at echo time t, generated by the system 200 using the inversion recovery pulse sequence 202 followed by the CPMG pulse sequence 204, can be written as (equation 1):

$$M = {M}_{0} ( 1 - 2 {e}^{- \frac{TI}{{T}_{1}}} ) {e}^{- \frac{t}{{T}_{2}}}$$

Here, T1 can be the inversion time in an IR-CPMG sequence (e.g., the inversion recovery pulse sequence 202 followed by the CPMG pulse sequence 204) and M₀ can be the spin magnetization at equilibrium when a constant and homogeneous static magnetic field B₀ is applied to the hydrocarbon pool 118.

In scenarios where a measured sample has a distribution of T₁-T₂ instead of single values, equation 1 can be expressed as (equation 2):

$${M}_{TI , t} = {M}_{0} {\sum }_{i , j} {f}_{i , j} ( 1 - 2 {e}^{- \frac{TI}{{T}_{1 , i}}} ) {e}^{- \frac{t}{{T}_{2 , j}}}$$

where, f_{i,j} can be the fraction of the hydrogen nuclei spins with relaxation times T_{1,j} and T_{2,j}.

In some instances, the NMR response includes an echo amplitude which is measured at different echo times t using various TI. An inversion of measured echo amplitudes based on the above equation can create a T₁-T₂ intensity map, which can be used to calculate fluid porosity and saturations.

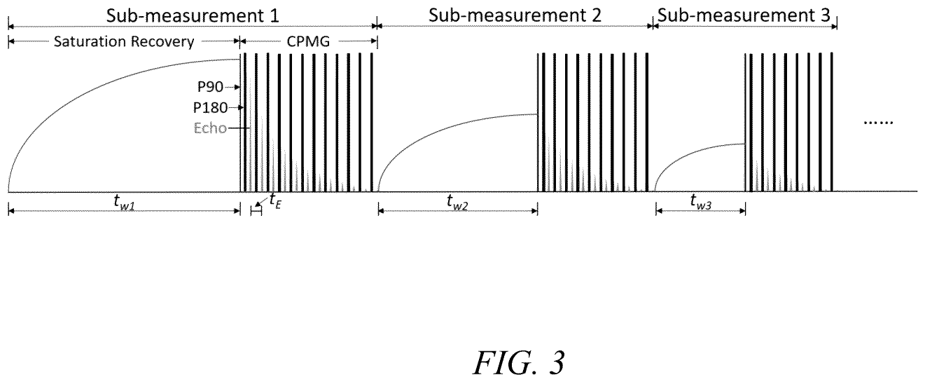

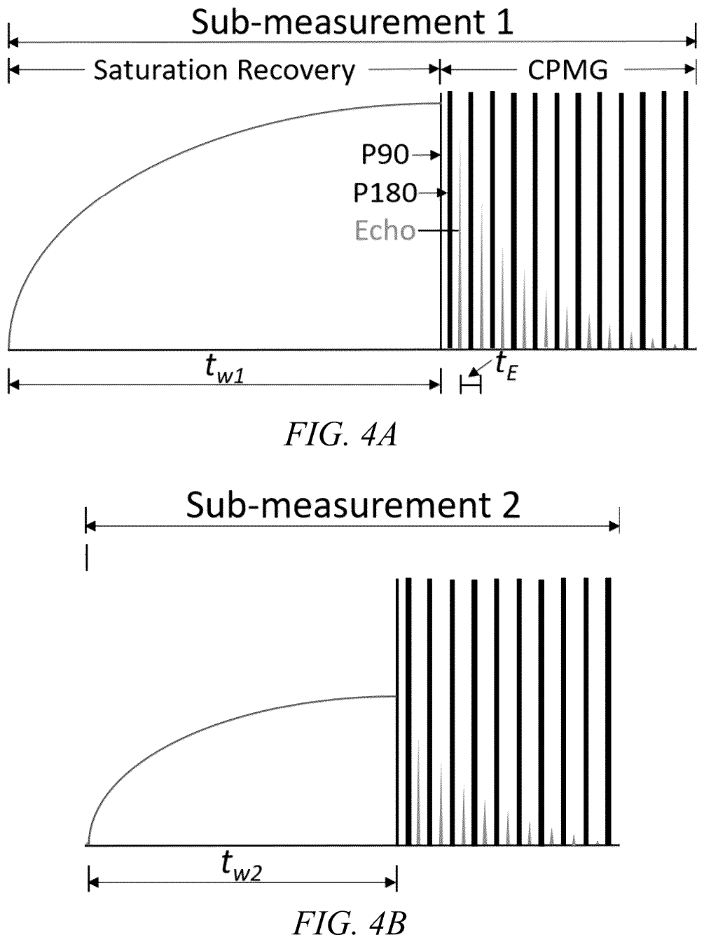

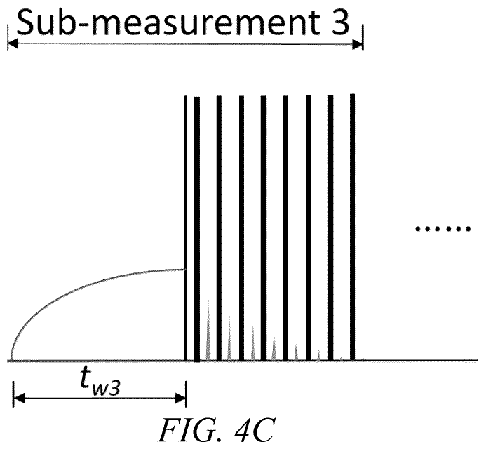

FIG. 3 illustrates an example of pulse sequence that can be performed using system 100. The pulse sequence in FIG. 3 includes a saturation recovery sequence followed by Carr-Purcell-Meiboom-Gill sequence (SR-CPMG), The pulse sequence includes a first sub-measurement (shown in FIG. 4A), a second sub-measurement (shown in FIG. 4B), and a third sub-measurement (shown in FIG. 4C). In this non-limiting example, each of the sub-measurement can use a different weight time t_{wi} (where the index i=1, 2,3, . . . ).

Often T₁ and T₂ values are in millisecond range, and the duration of radiofrequency (RF) pulse is in microsecond range. When T₁ and T₂ values are much longer than the duration of radiofrequency (RF) pulses, the spin echo magnetization (amplitude) at echo time t using SR-CPMG sequence can be written as:

$$M = {M}_{0} ( 1 - {e}^{- \frac{Tw}{{T}_{1}}} ) {e}^{- \frac{t}{{T}_{2}}} ,$$

where T_{W} is the wait time in SR-CPMG sequence and M₀ is the spin magnetization at equilibrium when a constant and homogeneous static magnetic field B₀ is applied to the sample.

When the measured sample has a distribution of T₁-T₂ instead of single values, equation can be expressed as:

$${M}_{signal} = {M}_{0} {\sum }_{i , j} {f}_{i , j} ( 1 - {e}^{- \frac{Tw}{{T}_{1 , i}}} ) {e}^{- \frac{t}{{T}_{2} , j}} ,$$

where f_{i,j} is the fraction of the spins with relaxation times T_{1,i} and T_{2,j}

In the NMR measurement, the echo amplitude is measured at different echo time t using various t_{w}. An inversion of measured echo amplitudes based on the above equation can be used to create a T₁-T₂ intensity map, which can be used to get fluid porosity and saturations. M₀ is proportional to the fluid volume and can be converted to formation fluid porosity with proper calibration.

In practical NMR measurement, the total measurement Mₜₒₜₐₗ, includes both the NMR signal term M_{signal}=M_{T1,t} and a noise term Mₙₒᵢₛₑ, and the above equation can be rewritten as Mₜₒₜₐₗ, which includes the measured noise Mₙₒᵢₛₑ, i.e.,

$${M}_{total} = {M}_{signal} + {M}_{noise}$$

The total measured amplitude of the echo is the sum of the signal amplitude from formation fluid and noise amplitude. Running the inversion on total measured amplitude of the echoes will give a different fluid porosity and T₁-T₂ map than the actual values of the formation fluid, causing errors in interpretation.

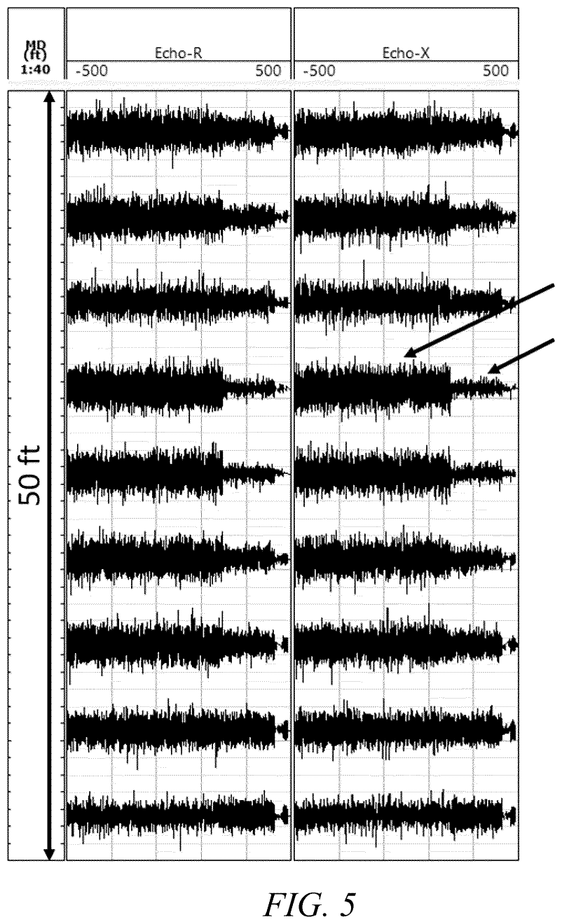

FIG. 5 illustrates an example of the echo data from NMR logging at different depths. The echo data is complex (i.e., the echo data includes complex numbers having a real value and an imaginary value). For the example shown in FIG. 5, the echo data at different depths is observed to have different amounts of noise. By comparing the echo amplitudes of the echo train, it can be observed that the noise levels of for a time period of the first two thirds of each echo train (which time period corresponds to sub-measurement 1) is greater than the noise observed the time period of the rest of the echo trains (which time period corresponds to the other sub-measurements). This signals that the echo data corresponding to sub-measurement can benefit from denoising.

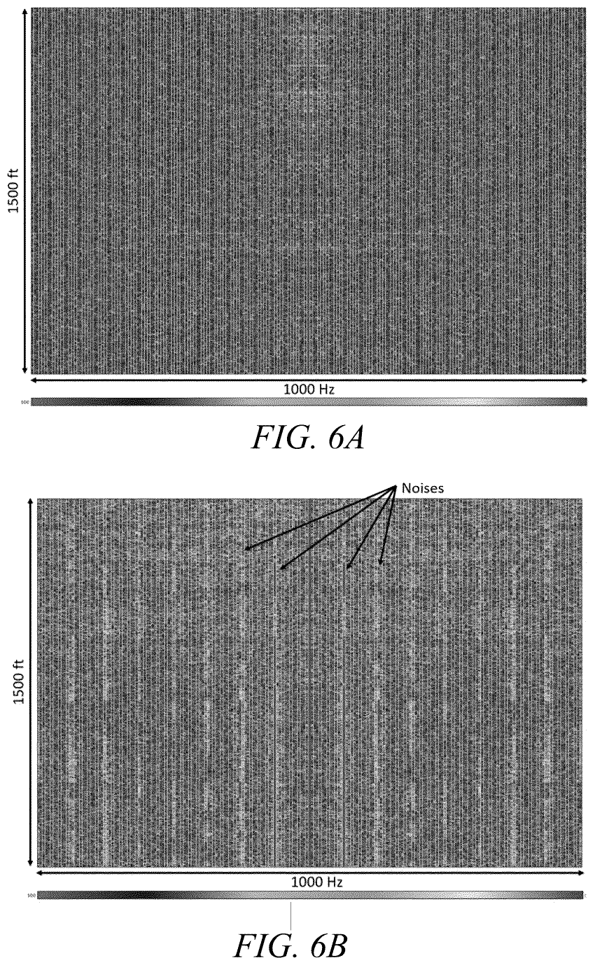

FIG. 6A and FIG. 6B illustrates an example of the echo data from NMR logging at different depths represented in the frequency domain. In FIG. 6A, the echo data from NMR logging has negligible noise, whereas, in FIG. 6B, the echo data from NMR logging has significant noise. In FIG. 6A and FIG. 6B, the amplitudes of the frequency coefficients shown in the plots are generated by taking a fast Fourier transform (FFT) of the ECHO signal, and these frequency coefficients are denoted as the ECHO_{FFT} data/signal. In both FIG. 6A and FIG. 6B, the frequency band width is 1,000 Hz and the depth interval is 1,1300 ft. In FIG. 6A, it is observed that the echo amplitude only shows large values near the central frequency, as expected for NMR data with negligible/normal noise levels. In contrast, in FIG. 6B, it is observed that, in addition to large amplitude at central frequency, there are also somewhat large amplitudes at a fundamental frequency of tens of Hz and its harmonics. Accordingly, the ECHO_{FFT} signal in FIG. 6B has additional environmental noises which can be beneficially reduced to generate corrected echo data.

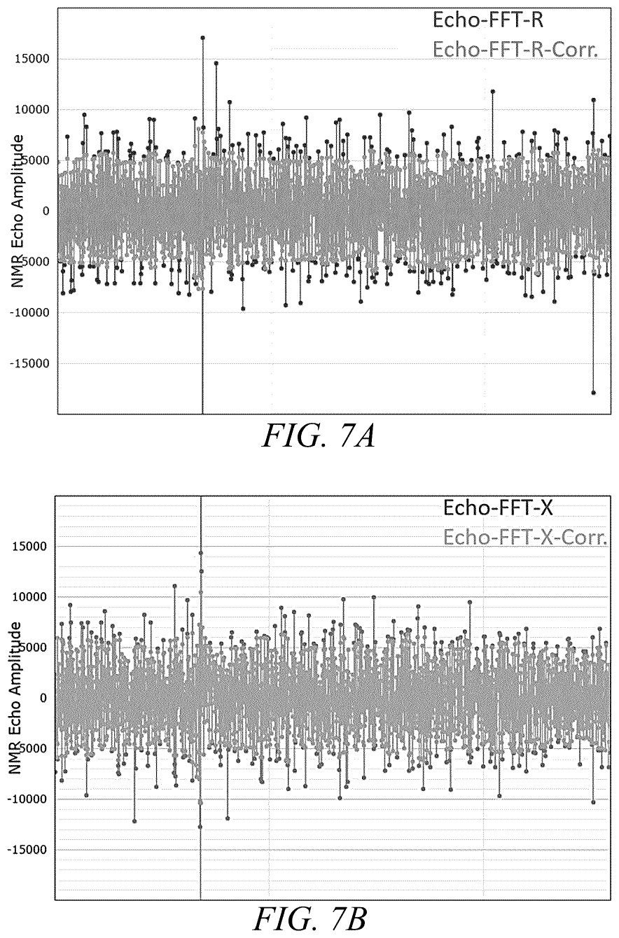

FIG. 7A and FIG. 7B show the ECHO_{FFT} signal (i.e., the echo data after FFT), with FIG. 7A showing the real part and FIG. 7B showing the imaginary part. The values shown in black are the original values and the superimposed grey values are the filtered/corrected values (i.e., ECHO_{FFT-Corr}). A moving filter is applied to generate a threshold value for the echo amplitude within the filter window. The filter window size/width is set based on the fundamental frequency of the additional environmental noise (i.e., the distance between noise peaks seen in FIG. 6B). Accordingly, window width of the moving average generated for the moving filter is large enough that the moving average in the frequency domain includes at least one noise peak within the filter window. The threshold in the window can be set based on a percentile (e.g., 90%) of the echo amplitude histogram within the window. During data correction, echo amplitudes exceeding the threshold can be set to the value of the threshold. Amplitudes less than the threshold remain unchanged.

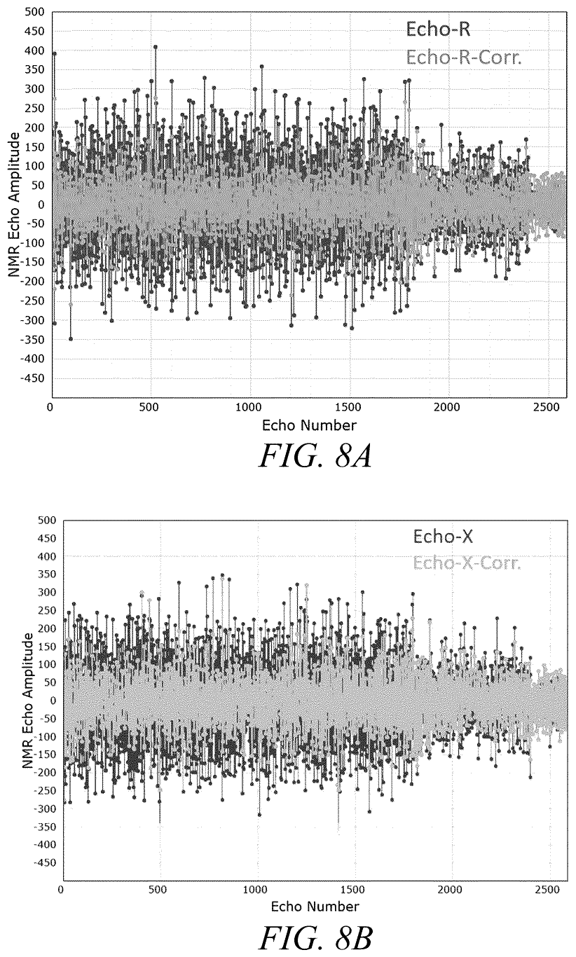

After applying this correction, the corrected echo data ECHO_{FFT-Corr} are transformed back from the frequency domain to the time domain (e.g., by applying an inverse FFT (IFFT) to the ECHO_{FFT-Corr} signal) to generate the ECHO_{Corr} signal. That is, after data correction, an IFFT can be performed on the ECHO_{FFT-Corr} signal to generate corrected echo train data (i.e., the ECHO_{Corr} signal). FIG. 8A and FIG. 8B show the ECHO_{Corr} signal in the time domain, which corresponds to the frequency domain signals shown in FIG. 7A and FIG. 7B. FIG. 8A shows the real part of ECHO_{Corr} and FIG. 8B showing the imaginary part of ECHO_{Corr}. The values shown in black are the original values of the ECHO data and the superimposed grey values are the filtered/corrected values ECHO_{Corr}.

Compared to the original echo data, the corrected echo data (both real and imaginary parts) can be observed as being less noisy. The results in FIG. 8A and FIG. 8B show that the environmental noise is reduced and therefore has less effect on the echo signal after being corrected. FIG. 7A, FIG. 7B, FIG. 8A, and FIG. 8B illustrate for one echo train (i.e., at one well depth) the improvements provided by denoising the ECHO data

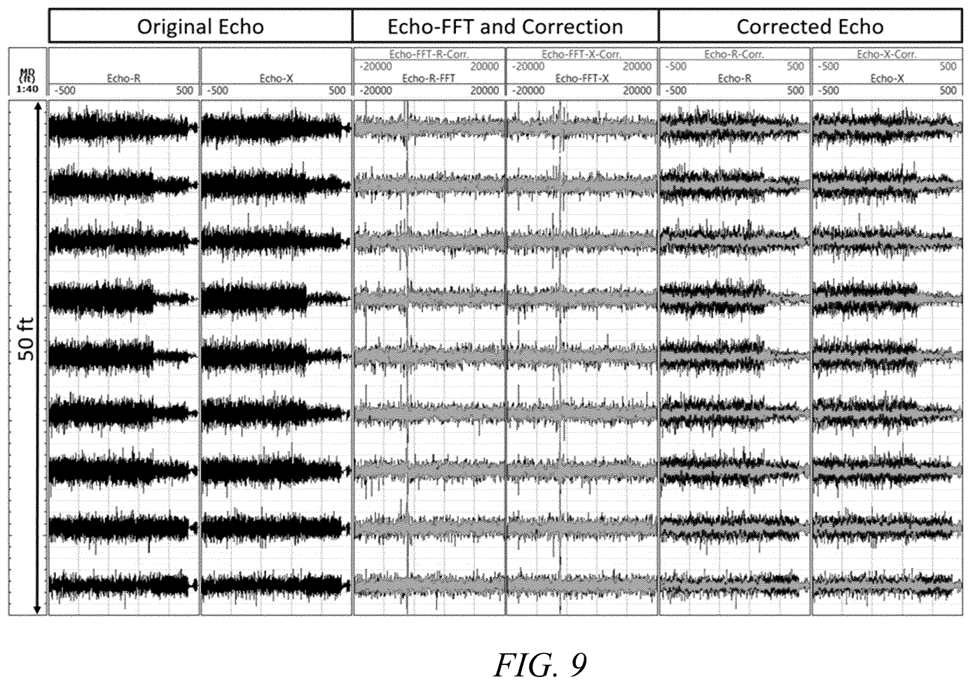

FIG. 9 illustrates, at multiple well depths, the improvements provided by denoising the ECHO data. FIG. 9 illustrates examples of the echo data in different steps of the data correction workflow at different depths. On the left, FIG. 9 illustrates the ECHO data before correction, which is also shown in FIG. 5. In the middle, FIG. 9 illustrates the frequency coefficients both before (ECHO_{FFT}, which is shown in black) and after correction (ECHO_{FFT-Corr}, which is shown in grey). On the right, FIG. 9 illustrates the echo trains in the time domain before (ECHO, which is shown in black) and after correction (ECHO_{Corr}, which is shown in grey). In each plot, the respective signals at the same height of the graph correspond to the same measurement depth in the well. For all depths, the corrected echo data can be observed as being less noisy than the original data. When the original data already has minimal noise, the correction is minimal. The correction is larger when the original ECHO signal has more noise.

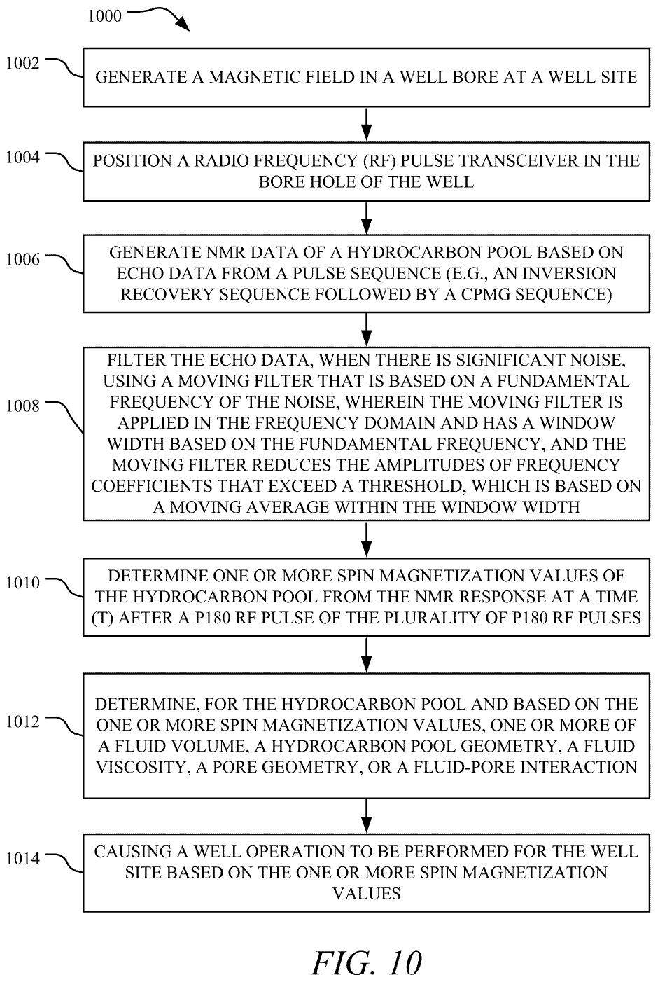

FIG. 10 illustrates an example method 1000 for NMR measurement, which can be performed by system 100 depicted in FIG. 1.

At operation 1002, method 1000 can generate a magnetic field in a wellbore at a well site.

At operation 1004, an RF transceiver is positioned in the well bore. The RF transceiver are configured to transmit RF signals into a volume proximate to the borehole to excite/change the magnetization of the hydrogen nuclei and to measure echo signals arising from the precession of the magnetization.

At operation 1006, the RF transceiver transmits a pulse sequence and measures the echo data. As a result of the pulse sequence and the magnetic field, NMR data is generated for a hydrocarbon pool. This NMR data includes the echo data from the pulse sequence (e.g., a saturation recovery sequence followed by a CPMG sequence or an inversion recovery pulse sequence followed by the CPMG pulse sequence).

For example, according to certain non-limiting examples, the pulse sequence can include a saturation recovery pulse sequence (or partial saturation recovery pulse sequence) followed by a CPMG pulse sequence. A partial saturation pulse sequence starts with a P90 pulse followed by waiting for a short period before applying another P90 pulse. This pattern is then repeated a predefined number of times. The measurements are obtained immediately after the 90° RF pulse. Based on the free induction decay (FID). The partial saturation pulse sequence is so named because the recovery time between P90 pulses is a short period (e.g., but not limited to, less than the longitudinal relaxation period to decrease the longitudinal magnetization by 1/e), meaning that longitudinal magnetization is only partially recovered before the next P90 pulse.

According to other non-limiting examples, the pulse sequence can include an inversion recovery pulse sequence followed by a CPMG pulse sequence. The inversion recovery pulse sequence can include an initial P180 RF pulse. For example, in an example of the inversion recovery pulse sequence, a P180 RF pulse is applied, and then after a period of time (the inversion time TI) a P90 RF pulse is applied followed by a spin echo sequence of P180 pulses at intervals TE spanning a time interval of t.

At operation 1008, the echo data is filtered using a moving filter, when there is significant noise in a given echo train. Filtering can be omitted for those echo trains having normal/minimal noise. As discussed with reference to FIG. 7A FIG. 7B, and FIG. 10, the moving filter is applied in the frequency domain and has a window width that is based on the fundamental frequency of the noise. The moving filter reduces the amplitudes of frequency coefficients that exceed a threshold, and the threshold can based on a moving average or histogram within the window of the moving filter. For example, the threshold in the window can be set based on a percentile (e.g. the 90^{th} percentile) of the histogram of frequency coefficients within the window.

At operation 1010, the method 1000 can be one or more spin magnetization values can be determined for the hydrocarbon pool. The spin magnetization values can be determined from the NMR response at a time (t) after a P180 RF pulse of the plurality of P180 RF pulses.

At operation 1012, the one or more spin magnetization values can then be used to derive one or more of a fluid volume, a hydrocarbon pool geometry, a fluid viscosity, a pore geometry, or a fluid-pore interaction. For instance, operation 1012 can include generating a T₁-T₂ map based on multiple spin magnetization values (e.g., a plurality of longitudinal relaxation time value and a plurality of transverse relaxation time value).

At operation 1014, a well operation can be performed for the well site based on the one or more spin magnetization values. For instance, operation 1014 can include selecting a drilling site, drilling to a particular drilling depth, performing well completion for the well bore hole, performing a shut-in procedure for the well bore hole, or performing an additional hydrocarbon pool characterization (e.g., using an additional inversion recovery pulse sequence and/or an additional CPMG pulse sequence) based on the one or more spin magnetization values. Accordingly, techniques performed by the systems discussed herein for NMR measurement can be integrated into a variety of practical applications by providing more accurate hydrocarbon characteristic information to improve the efficiency and accuracy of well operation procedures.

It is to be understood that the specific order or hierarchy of operations in the method depicted in FIG. 10 and throughout this disclosure are instances of example approaches and can be rearranged while remaining within the disclosed subject matter. For instance, any of the operations depicted in FIG. 10 and throughout this disclosure may be omitted, repeated, performed in parallel, performed in a different order, and/or combined with any other of the operations depicted in FIG. 10 or throughout this disclosure.

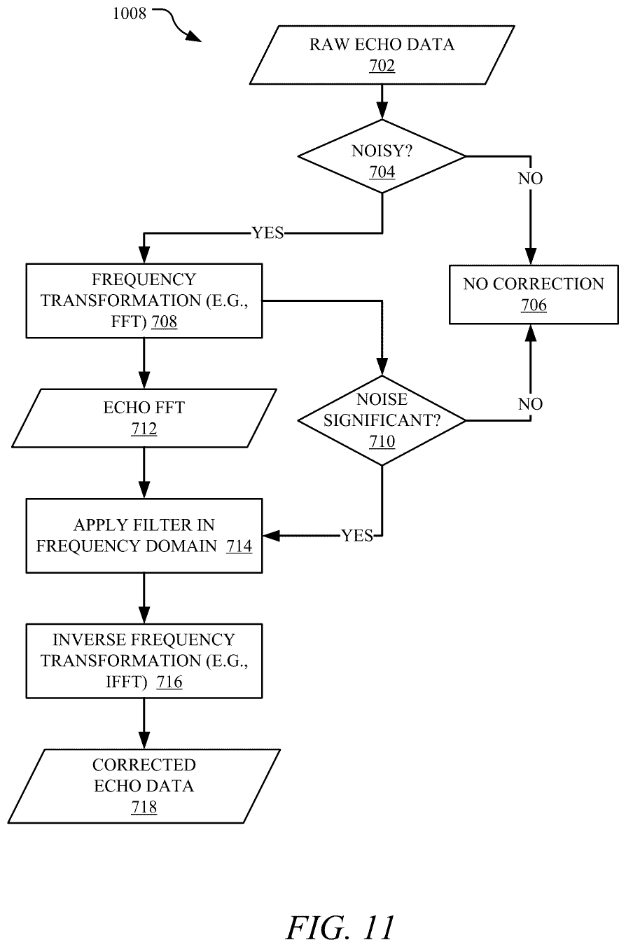

FIG. 11 illustrates an example flow diagram for performing operation 1008.

At step 704 of operation 1008, an inquiry is performed on the raw echo data 702 to determine whether the raw echo data 702 includes noise. This determination can be performed in a time domain, and the determination can be based on a statistical comparison to a baseline/normal noise level. For example, as illustrated in FIG. 5, some sub-measurements within a given echo train or pulse sequence may have a baseline/normal noise level and therefore provide a desired signal accuracy without denoising, whereas other sub-measurements may have greater noise levels than the baseline/normal noise level and therefore denoising these sub-measurements can beneficially improve the signal to noise ratio to provide the desired signal accuracy.

When the raw echo data 702 is determined to include noise, operation 1008 proceeds from step 702 to step 708, in which the raw echo data 702 is transformed to the frequency domain to generate the echo FFT 712, e.g., by applying an FFT to the raw echo data 702 (i.e., the ECHO signal) to generate the echo FFT 712 (i.e., the ECHO_{FFT} data).

When the raw echo data 702 is determined to be noisy, operation 1008 proceeds from step 702 to step 706.

At step 706 of operation 1008, no correction is applied to the raw echo data 702, which is used for the subsequent NMR analysis (e.g., determining the echo amplitudes, T₁ and T₂ relaxation times, etc.).

At step 710 of operation 1008, the noise is analyzed to determine whether it is significant. For example, the noise can be analyzed by comparing the noise in the frequency domain to the predefined noise threshold to determine whether the noise of the echo FFT 712 (i.e., the ECHO_{FFT} data) is greater than the predefined noise threshold. Additionally or alternatively, the noise is analyzed to determine whether it is of a type of noise that the filtering in step 714 is adapted to mitigate. For example, according to certain examples, the filtering in step 714 can be based on a noise harmonic, such that the filtering is adapted to mitigate noise that has a noise harmonic. Thus, the analysis of the noise can include an inquiry into whether the noise has a feature of periodic peaks in the frequency domain, as illustrated in FIG. 6B.

When step 710 determines that the noise in echo FFT 712 is significant, operation 1008 proceeds from step 710 to step 714. Otherwise, operation 1008 proceeds from step 710 to step 706. Step 706 is discussed above.

At step 714 of operation 1008, the echo data is denoised by applying a filter. For example, this denoising can be achieved by applying a moving filter in the frequency domain.

According to certain non-limiting examples, the filtering includes determining amplitude thresholds for respective frequency windows of a moving average that is applied, in the frequency-domain, to the echo FFT 712 (i.e., the ECHO_{FFT} data). The window size of the respective frequency windows is based on a fundamental frequency of the noise harmonic. For example, the window width can be selected to span at least a frequency range from one peak of a noise harmonic to a peak of an adjacent noise harmonic. The amplitude threshold can be based on a statistical analysis (e.g., based on the mode, median, mean, standard deviation, or higher statistical moments) of the frequency coefficients within the window width. For example, the amplitude threshold can be calculated based on an average value of frequency coefficients within the window, or based on a histogram of frequency coefficients within the window (e.g., the value of the frequency coefficient corresponding to the 90^{th} percentile of the histogram).

According to certain non-limiting examples, within the window, frequency coefficients that are less than the amplitude threshold can remain unchanged, whereas frequency coefficients that exceed the amplitude threshold are reduced. For example, step 714 can reduce the amplitude of a frequency component within a given window of the moving filter, when the frequency component exceeds the amplitude threshold corresponding to that given window. The moving filter can operate by sliding the window along the frequency axis of the echo FFT 712, and at each point along this axis, the amplitude threshold is determined and applied to reduce the amplitudes of frequency coefficients that exceed the amplitude threshold. According to certain non-limiting examples, frequency coefficients that exceed the amplitude threshold are reduced to have an amplitude equal to the amplitude threshold.

According to certain non-limiting examples, a moving filter is applied to get the amplitude threshold of the echo amplitude within the filter window. The filter window size is set based on the fundamental frequency of the additional environmental noises, such that on average there is at least one echo with abnormal amplitude within the filter window. The amplitude threshold in the window is set based on a percentile (e.g., the 90^{th} percentile) of echo amplitude histogram within the window. During data correction, the echo amplitudes exceeding the threshold are reset to the threshold value, and echo amplitudes lower than the threshold remains unchanged. After applying threshold correction, the corrected values for the echo FFT 712 are designated as ECHO_{FFT-Corr}.

At step 716 of operation 1008, the corrected values for the echo FFT 712 (ECHO_{FFT-corr}.) are transformed from the frequency domain to the time domain (e.g., using an inverse FFT) to generate the corrected echo data 718 (i.e., ECHO_{Corr}). The corrected echo data 718 (i.e., ECHO_{Cor}) is used for the subsequent NMR analysis (e.g., determining the echo amplitudes, T₁ and T₂ relaxation times, etc.).

Using the corrected echo data 718, various properties and aspects of the well reservoir can be determined. The corrected echo data 718 can be recorded as NMR logo data. As illustrated in FIG. 10, the NMR logo data can be used to determine one or more spin magnetization values of the hydrocarbon pool. Further, the spin magnetization values of the hydrocarbon pool can be used to determine one or more of a fluid volume, a hydrocarbon pool geometry, a fluid viscosity, a pore geometry, or a fluid-pore interaction, which are then used to inform a well operation to be performed for the well.

Additionally or alternatively, the NMR logo data can be interpreted by quantifying one or more fluid producibility parameters, for example. The one or more fluid producibility parameters may be quantified by processing the NMR log data using automated unsupervised machine learning. The one or more fluid producibility parameters may include, without limitation, fluid porosity and saturation, producible oil volume, matrix pore size, formation wettability, and/or the like. The NMR log data may be 2D NMR log data, and the interpreted NMR log may be a 2D log. In some examples, the interpreted NMR log includes one or more signatures of formation fluids. The one or more signatures of formation fluids may include, without limitation, gas, immovable hydrocarbons, producible oil, immovable water, and/or free water. The interpreted NMR log may include fluid and matrix properties. For example, the fluid and matrix properties may include fluid viscosity, pore geometry, fluid-pore interaction, and/or the like. In one implementation, the interpreted NMR log distinguishes fluid typing by separating spin-lattice relaxation time and spin-spin relaxation time signatures of pore-fluids.

The interpreted NMR log can be used to generate a production characterization of the reservoir based on the interpreted NMR log. The production characterization may include a characterization of saturation and producibility of hydrocarbons and water. In some examples, the production characterization includes a model of fluid producibility. The model of fluid producibility may include fluid porosity and saturation of oil, water, bound, and producible. In one implementation, the production characterization includes fluid mobility pore sizes and formation wettability determined based on spin-lattice relaxation time and spin-spin relaxation time signatures.

The reservoir may be developed based on the production characterization. Developing the reservoir may include extracting the resources from the reservoir based on the production characterization. In one example, the one or more wells includes a lateral well and developing the reservoir includes determining whether to drill and complete the lateral well. In another example, the one or more wells includes a horizontal well and developing the reservoir includes identifying a landing point for the horizontal well.

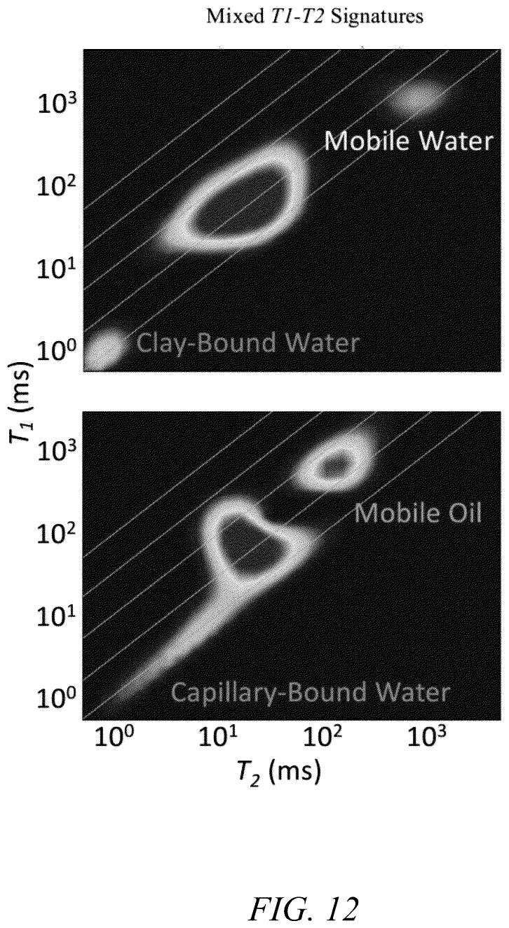

FIG. 12 illustrates plots representing mixed T1-T2 signatures, from which can be observed in-situ fluid types and volumetrics providing a reservoir characterization. Total water saturations from core and logs are significantly lower than the water cut from production. In this case, an NMR T1-T2 log can be used for fluid typing in reservoir characterization and in discriminating mobile oil in connection with the following:

$$T 1 / T 2 ( HC ) > T 1 / T 2 ( Water ) ; and$$

$$T 2 ( mobile fluid ) > T 2 ( immobile fluid ) .$$

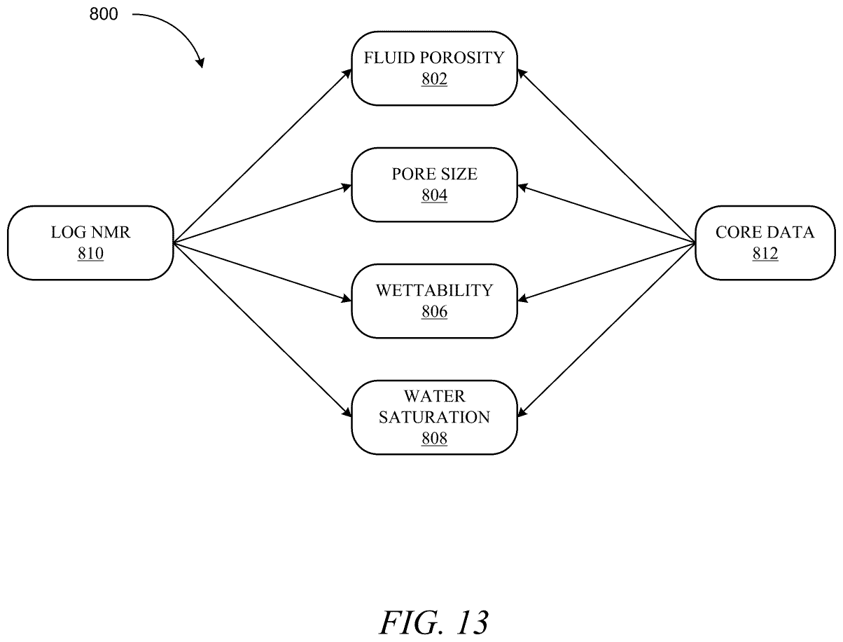

FIG. 13 illustrates a flow diagram 800 of a workflow using a log NMR 810 and core data 812 to characterize fluid porosity 802, pore size 804, wettability 806 and water saturation 808. In one implementation, integrated results, including fluid porosities 802, pore sizes 804, wettability indicator 806, and water saturation 808 are obtained from log NMR 810 and core data 812. Core porosity and saturation measures, scanning electron microscope (SEM) images, rock evaluation pyrolysis, wettability measurements, and mercury injection capillary pressure (MICP) tests, among other dynamic production results, may be used to calibrate and/or validate the reservoir production system For example, the fluid porosities 802 may be obtained through unsupervised learning using the log NMR 810 and the core data 812 in the form of Dean-Stark, retort, core NMR, and/or the like. The pore sizes 804 may be obtained using body size from T2 with core calibration from the log NMR 810 and body size from SEM and throat size from MICP from the core data 812. The wettability indicator 806 may be obtained using Archie saturation exponent n from electrical properties and contact angle from sessile drop test from the core data 812 and from the log NMR 810 using the following:

$${SW}_{IM} = \frac{{∅}_{immobile water}}{{∅}_{immobile water} + {∅}_{immobile HC}} .$$

The water saturation 808 may be obtained from the log NMR 810 and the core data 812 using the following:

$$SWT = \frac{{∅}_{immobile water} + {∅}_{mobile water}}{{∅}_{total}} ; and$$

$$SWF = \frac{{∅}_{mobile water}}{{∅}_{movbile water} + {∅}_{mobile oil}} .$$

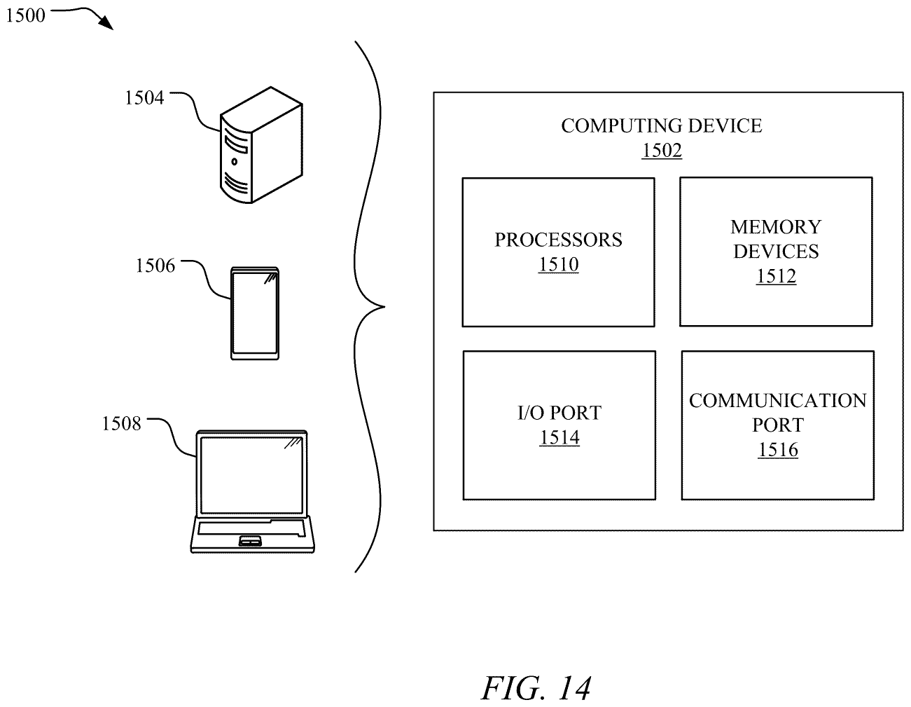

FIG. 14 illustrates a system 1500 for NMR measurement with amplitude correction using one or more computing devices 1502, which can form at least a portion of the system 100 depicted in FIG. 1. In one implementation, the one or more computing devices 1502 include one or more of a server 1504, a mobile device 1506, a laptop or desktop computing devices 1508, and/or various other devices, which can be located at the well site 104 and/or remote from the well site 104 (e.g., at one or more control centers 120).

In some instances, the computing devices 1502 includes a computer, a personal computer, a desktop computer, the laptop computer 1508, a terminal, a workstation, a cellular device, a mobile phone, the mobile device 1506, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, and/or the like. The computing device 1502 can be the server 1504, which may be one single server, a plurality of servers with each such server being a physical server or a virtual machine, or a collection of both physical servers and virtual machines. In another implementation, a cloud hosts one or more components of the system.

The computing devices 1502 may be integrated with, form a part of, or otherwise be associated with the systems 100-400. For instance, the computing devices 1502 can be at the control center 120 and/or with production personnel to perform the operations of the system 100-400. For instance, the computing device 1502 may be a computing system capable of executing a computer program product to execute a computer process. An NMR logging application can be stored and executed at the computing device 1502 (e.g., as one or more software components). Data and program files may be input to the computing device 1502 (e.g., corresponding to the inversion recovery pulse sequence 202, the CPMG pulse sequence 204, and equations 1-5) which can read the files, execute the programs, collect the data resulting corresponding to the NMR response, and determine the various reservoir properties from the NMR response. Moreover, the computing device 1502 can send an instruction to a well planning system, a well drilling system, and/or a well completion system to perform the well operation or other operational action in response to the reservoir properties determined from the NMR response.

Some of the elements of the computing device 1502 can include one or more hardware processors 1310, one or more memory devices 1512, and/or one or more ports, such as input/output (I/O) port 1514 and communication port 1516. Additionally, other elements that will be recognized by those skilled in the art may be included in the computing device 1502 but are not explicitly depicted in FIG. 14 or discussed further herein. Various elements of the computing device 1502 may communicate with one another by way of the communication port 1516 and/or one or more communication buses, point-to-point communication paths, or other communication means.

The processor 1510 may include, for example, a central processing unit (CPU), a microprocessor, a microcontroller, a digital signal processor (DSP), and/or one or more internal levels of cache. There may be one or more processors 1310, such that the processor 1510 comprises a single central processing unit, or a plurality of processing units capable of executing instructions and performing operations in parallel with each other, commonly referred to as a parallel processing environment.

The computing device 1502 may be a stand-alone computer, a distributed computer, or any other type of computer, such as one or more external computers made available via a cloud computing architecture. The presently described technology is optionally implemented in software stored on data storage devices such as the memory devices 1512, and/or communicated via one or more of the I/O port 1514 and the communication port 1516, thereby transforming the computing device 1502 in FIG. 14 to a special purpose machine for implementing the operations described herein. Moreover, the unconventional arrangement of components of the computing devices 1502 with the NMR unit 114 for generating the RF pulses 116 and collecting NMR response data improves the field of technology of NMR measurement.

The one or more memory devices 1512 may include any non-volatile data storage device capable of storing data generated or employed within the computing device 1502, such as computer-executable instructions for performing a computer process, which may include instructions of both application programs and an operating system (OS) that manages the various components of the computing device 1502. The memory devices 1512 may include, without limitation, magnetic disk drives, optical disk drives, solid state drives (SSDs), flash drives, and the like. The memory devices 1512 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 1512 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory devices 1512 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

In some implementations, the computing device 1502 includes one or more ports, such as the I/O port 1514 and the communication port 1516, for communicating with other computing, network, or vehicle devices. It will be appreciated that the I/O port 1514 and the communication port 1516 may be combined or separate and that more or fewer ports may be included in the computing device 1502.

The I/O port 1514 may be connected to an I/O device, or other device, by which information is input to or output from the computing device 1502. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 1502 via the I/O port 1514. Similarly, the output devices may convert electrical signals received from the computing device 1502 via the I/O port 1514 into signals that may be sensed as output by a human, such as sound, light, and/or touch. The input device may be an alphanumeric input device, including alphanumeric and other keys for communicating information and/or command selections to the processor 1510 via the I/O port 1514. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In one implementation, the communication port 1516 is connected to a network and the computing device 1502 may receive network data useful in executing the methods and systems set out herein as well as transmitting information and network configuration changes determined thereby. Stated differently, the communication port 1516 connects the computing device 1502 to one or more communication interface devices configured to transmit and/or receive information between the computing device(s) 1502 and other computing device(s) 1502 (e.g., located at the well site 104 and/or remotely from the well site 104) by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 1516 to communicate one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 1516 may communicate with an antenna or other link for electromagnetic signal transmission and/or reception.

The system 1500 set forth in FIG. 14 includes but one possible example of the computing device(s) 1502 that may employ or be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 1502.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of denoising nuclear magnetic resonance (NMR) data, the method comprising:
generating NMR data using an NMR device in a bore hole of a well;
identifying a noise harmonic in the NMR data;
applying a first filter to the NMR data to generate filtered NMR data, wherein the first filter is based on the noise harmonic that is identified in the NMR data;
determining one or more spin relaxation times based on the filtered NMR data; and
performing an analysis using the one or more spin relaxation times to at least one of generate an MR image or determine a reservoir property of the well.

2. The method of claim 1, wherein the reservoir property of the well includes one or more of porosity, permeability, wettability, irreducible water saturation, and irreducible oil saturation.

3. The method of any of claim 1, wherein:
the one or more spin relaxation times comprise longitudinal relaxation times and transverse relaxation times at respective depths along the bore hole of the well and/or at a transverse location with respect to the bore hole of the well, and
the analysis includes at least one of determining the reservoir property of the well as a function of the respective depths along the bore hole or a function of the transverse location with respect to the bore hole of the well.

4. The method of claim 1, further comprising:
identifying the noise harmonic in the NMR data includes determining whether the NMR data includes noise that is greater than a predefined noise threshold;
determining the one or more spin relaxation times based on the NMR data without applying the first filter to the NMR data, when the noise of the NMR data is determined to not exceed the predefined noise threshold and needs further analysis; and
applying the first filter to the NMR data and determining the one or more spin relaxation times based on the filtered NMR data, when the noise of the NMR data is determined to exceed the predefined noise threshold.

5. The method of claim 4, wherein determining whether the noise of the NMR data is greater than the predefined noise threshold further comprises:
determining in a time domain whether the NMR data includes the noise; and
when the NMR data is determined to include the noise, transforming the NMR data to a frequency domain and comparing the noise in the frequency domain to the predefined noise threshold to determine whether the noise of the NMR data is greater than the predefined noise threshold.

6. The method of claim 1, wherein the first filter is applied to the NMR data in a frequency domain by:
transforming the NMR data to the frequency domain to obtain frequency-domain NMR data;
determining amplitude thresholds for respective frequency windows of a moving average applied to the frequency-domain NMR data, wherein a window size of the respective frequency windows is based on a fundamental frequency of the noise harmonic;
reducing an amplitude of a frequency component within a given frequency window of the respective frequency windows, when the frequency component exceeds one of the amplitude thresholds corresponding to the given frequency window, to generate filtered frequency-domain NMR data; and
transforming the filtered frequency-domain NMR data from the frequency domain to a time domain to generate filtered NMR data.

7. The method of claim 6, wherein reducing the amplitude of the frequency component within the given frequency window comprises that the frequency component that exceeds one of the amplitude thresholds corresponding to the given frequency window is reduced to have an amplitude that is equal to the one of the amplitude thresholds.

8. The method of claim 6, wherein another amplitude of the frequency component within the given frequency window that does not exceed one of the amplitude thresholds corresponding to the given frequency window remains unchanged when applying the first filter.

9. The method of claim 1, wherein generating the NMR data comprises:
positioning a radio frequency (RF) transceiver in the bore hole of the well;
generating a magnetic field in the bore hole;
generating, using the RF transceiver, an inversion recovery pulse sequence or a saturation recovery pulse sequence; generating;
generating, using the RF transceiver, a Carr-Purcell-Meiboom-Gill (CPMG) pulse sequence including a plurality of P180 RF pulses, wherein the magnetic field, the inversion recovery pulse sequence, and the CPMG pulse sequence cause a nuclear magnetic resonance (NMR) response from a hydrocarbon pool within a transmission range of the RF transceiver; and
determining one or more spin magnetization values of the hydrocarbon pool from the NMR response after a P180 RF pulse of the plurality of P180 RF pulses.

10. The method of claim 9, further comprising determining, for the hydrocarbon pool and based on the one or more spin magnetization values, at least one of:
a fluid volume;
a hydrocarbon pool geometry;
a fluid viscosity;
a pore geometry; or
a fluid-pore interaction.

11. The method of claim 9, further comprising:
using a result of the analysis to cause a well operation to be performed for a well site based on the one or more spin magnetization values.

12. The method of claim 11, wherein the well operation includes at least one of:
selecting a drilling site;
drilling to a particular drilling depth;
performing well completion for the bore hole;
performing a shut-in procedure for the bore hole; or
performing an additional hydrocarbon pool characterization.

13. A system comprising:
a nuclear magnetic resonance (NMR) device comprising:
a magnet configured to generate a magnetic field, and
a radio frequency (RF) transceiver configured to transmit one or more pulse sequences and receive echo pulse signals;
one or more processors; and
a memory storing instructions that, when executed by the one or more processors, configure the system to:
generate NMR data using the NMR device in a bore hole of a well;
identify a noise harmonic in the NMR data;
apply a first filter to the NMR data to generate filtered NMR data, wherein the first filter is based on the noise harmonic that is identified in the NMR data;
determine one or more spin relaxation times based on the filtered NMR data; and
perform an analysis using the one or more spin relaxation times to at least one of generate an MR image or determine a reservoir property of the well.

14. The system of claim 13, wherein the reservoir property of the well includes porosity, permeability, wettability, irreducible water saturation, and irreducible oil saturation.

15. The system of claim 13, wherein, when executed by the one or more processors, the instructions further configured to cause the system to:
identify the noise harmonic in the NMR data includes determining whether the NMR data includes noise that is greater than a predefined noise threshold;
determine the one or more spin relaxation times based on the NMR data without applying the first filter to the NMR data, when the noise of the NMR data is determined to not exceed the predefined noise threshold and needs further analysis; and
apply the first filter to the NMR data and determining the one or more spin relaxation times based on the filtered NMR data, when the noise of the NMR data is determined to exceed the predefined noise threshold.

16. The system of claim 13, wherein, when executed by the one or more processors, the instructions further configured to cause the system to:
determine whether noise of the NMR data is greater than a predefined noise threshold further by:
determining in a time domain whether the NMR data includes the noise; and
when the NMR data is determined to include the noise, transforming the NMR data to a frequency domain and comparing the noise in the frequency domain to the predefined noise threshold to determine whether the noise of the NMR data is greater than the predefined noise threshold.

17. The system of claim 13, wherein the first filter is applied to the NMR data in a frequency domain by:
transforming the NMR data to the frequency domain to obtain frequency-domain NMR data;
determining amplitude thresholds for respective frequency windows of a moving average applied to the frequency-domain NMR data, wherein a window size of the respective frequency windows is based on a fundamental frequency of the noise harmonic;
reducing an amplitude of a frequency component within a given frequency window of the respective frequency windows, when the frequency component exceeds one of the amplitude thresholds corresponding to the given frequency window, to generate filtered frequency-domain NMR data; and
transforming the filtered frequency-domain NMR data from the frequency domain to a time domain to generate filtered NMR data.

18. The system of claim 17, wherein reducing the amplitude of the frequency component within the given frequency window comprises that the frequency component that exceeds the one of the amplitude thresholds corresponding to the given frequency window is reduced to have an amplitude that is equal to the one of the amplitude thresholds.

19. The system of claim 18, wherein another amplitude of the frequency component within the given frequency window that does not exceed the one of the amplitudes threshold corresponding to the given frequency window remains unchanged when applying the first filter.

20. The system of claim 13, wherein, when executed by the one or more processors, the stored instructions further configured to cause the system to generate the NMR data by:
positioning the RF transceiver in the bore hole of the well;
generating a magnetic field in the bore hole;
generating, using the RF transceiver, an inversion recovery pulse sequence;
generating, using the RF transceiver, a Carr-Purcell-Meiboom-Gill (CPMG) pulse sequence including a plurality of P180 RF pulses, wherein the magnetic field, the inversion recovery pulse sequence, and the CPMG pulse sequence cause an NMR response from a hydrocarbon pool within a transmission range of the RF transceiver; and
determining one or more spin magnetization values of the hydrocarbon pool from the NMR response after a P180 RF pulse of the plurality of P180 RF pulses.
